(19) United States
(12) Patent Application Publication
(10) Pub. No.: US 2014/0025404 A1
(43) Pub. Date: Jan. 23, 2014

(54) SYSTEMS AND METHOD AND COMPUTER PROGRAM PRODUCT FOR DETERMINING CONSUMER NEGOTIABLE AUTOMOBILE ACCIDENT AND INJURY CALCULATIONS

(71) Applicants: Clemist Lamar Jackson, Marietta, GA (US); Teresa Jackson, Marietta, GA (US); Roderick Milliken, Pineville, NC (US)

(72) Inventors: Clemist Lamar Jackson, Marietta, GA (US); Teresa Jackson, Marietta, GA (US); Roderick Milliken, Pineville, NC (US)

(21) Appl. No.: 13/919,139

(22) Filed: Jun. 17, 2013

(51) Int. Cl. G06Q 40/08

(52) U.S. Cl. CPC G06Q 40/08
USPC 705/4

(57) ABSTRACT

Consequently, the CONSUMER CLAIM SOLUTION SOFTWARE [CCSS] program affords the user a comprehensive feedback on all of the pertinent variables of an automobile accident scenario. It also provides options for inclusion in the proposed negotiation which are designed to place the user within the same scope of expertise as the insurance professional in which the user will negotiate, thus providing a potentially more lucrative settlement.

The CONSUMER CLAIM SOLUTION SOFTWARE [CCSS] program presented herein greatly enhances the consumer's ability to satisfactorily settle an automobile accident claim case, and simultaneously minimizes the time and expense of maintaining and processing the claim for an insurance company. The longer large numbers of claims remain open, the more costly it is to property & casualty insurers. A quicker settlement, even if with a higher claimant payout is preferable to a longer tail, involving human resources costs, and a nominally higher payout to a representing Attorney.

### FIELD

The present invention largely concerns systems, methods and devices for calculating and estimating automobile accident physical loss property damage values, injury values, pain & suffering calculations for the purpose of consumer negotiation with a property & casualty insurer to close cases more expediently, with higher settlements.

### BACKGROUND

Consumers, who become involved in automobile accidents, have a low probability of deriving optimal settlement results when negotiating claims against an experienced claim adjuster representing an insurer. The vast percentages of drivers have a low I.Q. regarding the automobile claim process, values within the process and little known automobile claim entitlements. There is limited accessible public knowledge regarding the nuances of claim values, aside from the normal calculations of vehicle damage or total loss values, which are estimated via various loss calculators. Therefore, without legal assistance, most consumers are duped by the conclusion of their individual settlement processes. Those who utilize legal assistance normally forfeit a minimum of 33 ⅓% of the final settlement. An appreciable percentage of Attorney-represented cases could be favorably settled on a “do-it-yourself” with the availability of better help resources. Unfortunately, consumers have had no viable means to include the nuances [generally only known by experienced insurance adjusters] when they negotiate on their own. The presently referenced software fills a void, which has existed since the first automobile accident occurred in Ohio City, Ohio in 1891.

The present inventors diagnosed a dire necessity for an automated method which, on a do-it-yourself-basis, would educate automobile accident victims, include constructive calculated values and provide negotiation solution steps for their specific accident type. The end result is more empowerment and a much higher probability to successfully negotiate higher valued and more expediently settled automobile accident cases.

### BRIEF SUMMARY

Computer systems, methodology, device, and computer-readable data storage media warehousing directives for executing vehicle loss, physical loss and pain & suffering calculations for the purpose of consumer negotiation with a property & casualty insurer to close cases more expediently, with higher settlements. In an embodiment, a computer format for performing vehicle loss calculations, physical loss and pain & suffering calculations includes an electronic device coupled to the computer and the CONSUMER CLAIM SOLUTION SOFTWARE [CCSS]. The storage device includes a multifaceted application program having operational instructions to direct the software program to receive accident and injury variables, which includes geographical jurisdictions and forward to a calculator application. The instructions also command the software to allow the user to input automobile accident variables, which are state, vehicle and circumstantially-specific, with verification to assure accurate responses to questions regarding the incident. The culmination of user input and software calculations is a readable set of instructions to negotiate a higher value automobile insurance accident claim settlement.

In some embodiments, the commands for calculating within the CONSUMER CLAIM SOLUTION SOFTWARE [CCSS] program involves a holistic automobile accident variable analysis, involving each aspect of the accident, supported by pre-formatted and pre-determined most suitable variable-sensitive solution directing an automobile accident-specific variable-based approach for user negotiation to successfully close an automobile accident claim. In some implementations, the directions and options listed for negotiation include apparent vehicle conditions prior to and after collision, along with physical human ambulatory conditions after the accident causing injury. This approach is influenced by accident-related factors including time-of-day, weather conditions and event influencing circumstances such as jurisdiction and vehicle positioning of the party using the service. Some embodiments may also encompass operating instructions to direct the software to include practical steps necessary to influence an automobile accident claim outcome in a positive manner, based upon minor to serious physical injury accident results, which may or may not have resulted in a post-accident operation or multiple operations, with possible pending operation and physical therapy.

In some embodiments of the computer system, before acceptance of a user-supplied identification number and password, instructions may be provided via signal to command the CONSUMER CLAIM SOLUTION SOFTWARE [CCACSS] to synchronize with the application developed for an Advanced Automatic Collision Notification System to allow receipt of signals and transmitted information to pre-populate a specially designed portal repository awaiting physical verification of the transmitted automobile accident details, based upon membership and/or pre-existing corporate affinity code of the entity owner of the Advanced Automatic Collision Notification System.

In some embodiments of the computer system, before acceptance of the user identification number and password, instructions may be provided via signal to command the CONSUMER CLAIM SOLUTION SOFTWARE [CCACSS] to access and receive a temporary user identification number and password simultaneously from an Advanced Automatic Collision Notification System, resulting from a collision or vehicle impact by a prospective user, based upon membership and pre-existing corporate affinity code of the entity owner of the Advanced Automatic Collision Notification System.

In an additional feature, methods for providing calculation for physical property damage and bodily injury and steps for negotiation are disclosed. In an embodiment, the method includes software analysis of the list of all pertinent components of the automobile accident and injury process in terms of actions, results, values and costs of services. The method also encompasses providing user access to a detailed list of questions in various input fields, at least one option for input within a data input field or via a multiple choice option basis, an option to point and click on a 360 degree vehicle image to accurately identify single or multiple damage sources, an option to point and click on a 360 degree male or female body image to accurately identify single or multiple injury sources and instructions to calculate and access the database for action steps are based upon data entered by the user within the data input fields. The method also includes a verification of data completeness within the framework of user input, providing verification of all input for user agreement or editing, then re-verification of completeness within the same framework of user input, providing additional verification of all input for user agreement until all input is agreed upon by the user. Thus, upon agreement, the software will be directed to calculate all variables, providing output of physical property damage, bodily injury and pain and suffering values and steps to the user, based upon which is applicable to the user-provided details of the automobile accident.

In some embodiments, the method for estimating the output of values may strategically include determining ancillary costs and follow up treatment for bodily injury based upon the severity of the injury and user input on current cost incurred, operations received, pending operations. Some embodiments may also beneficially include storing in a memory the net amount, the negotiation steps, the accident date, the date the user interfaced the software, the user identification number and the internal system-generated claim number. The method may also include storing the variables in memory for the purpose of developing a database to analyze geographical and claim case characteristic trends.

In some implementations, as user is providing data, the software immediately initiates the construction of an outline of inputted information, while the software system is instantly being directed to access possible solutions based upon the specific factors involved in the automobile accident, along with all variations of involved parties, encompassing primary and ancillary information available at the pre-determined most suitable variable-sensitive solution level based upon the accident information entered, and the steps to pursue for the most ideal negotiable outcome. In some embodiments, before providing calculations and feedback, the program is alerted whether to continue or cease, based upon whether or not the user provides material input required for the software to calculate a most ideal negotiable outcome. In some embodiments, before providing calculations and feedback, the program is alerted whether to continue or initiate calculations and feedback at a lesser internal menu level, based upon whether or not the user provides enough material input required to result in the software calculating a pre-determined most suitable variable-sensitive solution and solution level, encompassing primary and ancillary information available at the next level of internal menu appropriate level choices which includes bodily injury at specific thresholds. If there are no bodily injury input variables, or if the user input of bodily injury variables and amounts do not reach a pre-determined threshold, the software is instructed to cease pursuing answers to additional questions designed to gain variables for calculating a more in-depth pre-determined most suitable variable-sensitive solution and solution level.

Another feature of the software is a computer readable medium storing permanent procedures for commanding evaluation and calculation methodology. The commands are designed to cause the calculation segment of the software to perform the scheme (s) for running the presently referenced automobile claim solution software.

The CONSUMER CLAIM SOLUTION SOFTWARE program [CCSS] presented herein greatly enhances the consumer's ability to satisfactorily settle an automobile accident claim case, and simultaneously minimizes the time and expense of maintaining and processing the claim for an insurance company. The longer the claim remains open, the more costly it is to an insurance company, due to mandated reserve requirements. A quicker settlement, even if with higher claimant payout, might be preferable to a longer tail, involving human resources costs, reserving, and/or a slightly higher payout to a representing Attorney, when analyzed within the context of large numbers of claims hedged upon “The Law of Large Numbers” concept used by property & casualty insurance companies. The invention methodology works by capturing accident-related variables, aligning the individual user responses with pre-formatted solutions, calculating user financial variables based upon forecasting formulas, while matching the collective user responses with the most appropriate pre-formatted course of action and steps for self-help resolution. The accident location will alert the corresponding location solution segment of the program to provide insight on the jurisdiction where the accident took place, along with statues governing how fault is determined. Fault, another sub-routine, will also regulate which pre-formatted solution will be activated.

Existing formula-based claim and total loss software is geared toward insurance companies which underwrite and sell automobile insurance policy contracts. These software designs are devised for the purposes of providing a range of property damage settlement, based upon current damage-related parts pricing, labor which may be geographically influence; or they may also be based upon cost containment, and usury of networks of body shop countrywide; and devised for the purpose of providing a range of bodily injury treatment, hospitalization and physical therapy costs which may be geographically influenced, or may also be based upon cost containment. Other software designs are intended for the purposes of calculating total losses, which primarily benefits insurance company operations. The CONSUMER CLAIM SOLUTION SOFTWARE [CCSS], a consumer focused program, provides individual financial formula-based outcomes, along with specific techniques for successful case closure for consumers, who purchase insurance from insurance companies, and ultimately must negotiate with those companies in automobile accident claim events. Other web sites have highlighted fragmented portions of claim settlement. None have comprehensively tied all major components together, whereby a software facilitates and triggers an electronic system which provides the user a pre-formatted logical categorical pre-determined most suitable variable-sensitive solution and solution level, encompassing primary and ancillary information available at the appropriate level, combined with consumer-related solution-based steps for an array of automobile accident characteristics. Other narrowly-scoped online calculators provide limited property damage and/or bodily injury outcomes, without techniques or specific steps for usage. They are fragmented, and do not provide the user with enough substantive information to be considered a viable alternative to legal representation. Current system limitations provide specified information. They do not comprehensively connect multiple components of the accident case, and therefore leave the user without enough information to influence multiple aspects of an automobile accident claim. The CONSUMER CLAIM SOLUTION SOFTWARE [CCSS] program solicits detailed information from the user, thus allowing the user to provide specific and personal variables which determines the output of the software calculations, making each solution as unique as the circumstances surrounding the automobile accident event itself.

In some implementations, other features of the software embodies the means by which the software can be configured for the purpose of providing consumer solutions for negotiating commercial automobile and property claims: personal property and commercial property, using a logical array of sequences to make it possible to arrive at the most suitable conclusion by utilizing the presently described claim methods according to aspects of the invention that may be performed by the CONSUMER CLAIM SOLUTION SOFTWARE [CCSS].

### BRIEF DESCRIPTION OF THE DRAWINGS

Features and benefits of some embodiments, and the methods in which they are completed, will reveal themselves with emphasis to the ensuing in-depth descriptions evaluated in aggregation with the attending drawings, which illustrate ideal embodiments (not illustrated to scale), wherein:

FIG. 1 is a diagram of a method for importing data from several sources, including user input, via the data network interface for the purpose of vehicle physical property damage, bodily injury and pain & suffering calculations and solutions generated by the CONSUMER CLAIM SOLUTON SOFTWARE, corresponding to an embodiment of the invention;

FIG. 2 is an illustration of data flows involved in importing data from information several sources, including user input, thus generating vehicle physical property damage, bodily injury and pain & suffering calculations and solutions generated by the CONSUMER CLAIM SOLUTON SOFTWARE, which is subsequently sent to the database, corresponding to an embodiment of the invention;

FIG. 3 is block diagram illustration of the components of a computer which may express features according to the invention of the CONSUMER CLAIM SOLUTION SOFTWARE program shown in FIG. 2, where information is placed into a vehicle damage database.

FIG. 4 is block diagram illustration of the components of a computer which may express features according to the invention of the CONSUMER CLAIM SOLUTION SOFTWARE program shown in FIG. 2, where information is placed into a bodily injury database.

FIG. 5 is block diagram illustration of a block diagram representation of a computer that may embody aspects according to the invention of the CONSUMER CLAIM SOLUTION SOFTWARE program.

FIG. 6 is an illustration of data flows involved in creating vehicle physical property damage, and/or bodily injury and/or pain & suffering solution levels and instructions in accord with features of the invention; and

FIG. 7 is a block diagram representation of a CONSUMER CLAIM SOLUTION SOFTWARE program system, in accordance with further aspects of the invention.

### DETAILED DESCRIPTION OF THE INVENTION

Overall, and for the intentions of presenting conceptions of embodiments of the present invention, the CONSUMER CLAIM SOLUTION SOFTWARE program engine automatically calculates vehicle loss physical damage calculations, physical bodily injury calculations and pain & suffering calculations for the purpose of consumer negotiation with a property & casualty insurer by the user of the program. The user is given a pre-formatted logical arrangement of computer-implemented guidelines and options which, the user may follow for the purpose of deriving a higher settlement, with a shorter time frame for case closure.

In an embodiment, after the user has either established an initial user identification number and password, or confirms identification and establishes a password based upon membership and pre-existing corporate affinity code of the entity owner of the Advanced Automatic Collision Notification System, the user information, when executed via a user's desktop or mobile automated device, generates a user interface viewable on a presentation device joined to the user's device, thus displaying to the user, in a first segment of the user interface, a multitude of solicitations for a set of personal information describing characteristics of the user, automobile accident variables, related injury and financial information received since the accident occurred; receiving via the user interface, or automated facilitator, the personal and accident-related set of information; based on the set of personal information describing characteristics of the user, automobile accident variables, related injury and financial information received since the accident occurred, verifying requested input, displaying the multitude of questions and results category simultaneously, generating to a second segment of the user interface a worksheet of injury information to be entered by the user, based upon the severity of the information entered into the first segment of the user interface, verifying requested input; generating to a third segment of the user interface a worksheet a second worksheet of injury information to be entered by the user, based upon the type of injury information entered into the second segment of the user interface, verifying requested input. The viewable user interface displays the multitude of questions and resulting instructions designed for negotiation based upon a pre-formatted and pre-determined most suitable variable-sensitive solution and solution level, encompassing primary and ancillary information available at the appropriate level, which is available to the user.

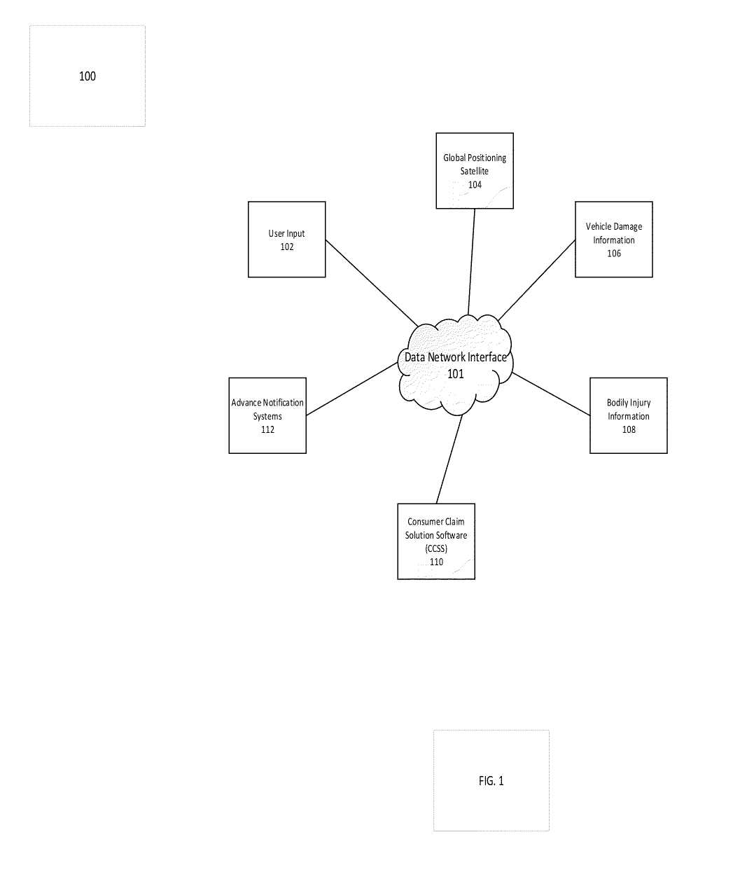

FIG. 1 is block diagram of an embodiment of a CONSUMER CLAIM SOLUTION SOFTWARE Data Network Interface 100 whereby the software accesses several external databases for the purpose of building components of the total claim for proper evaluation, calculation and solution. The CONSUMER CLAIM SOLUTION SOFTWARE Data Network Interface 100 for example may encompass several types of Data Network Interface input 101 to receive, route, facilitate and format received input. User Input 102 may be utilized for providing specific user details from an assorted number of devices. Details from User Input 102 may trigger access and download from for example a Global Positioning Satellite provider 104 such as GOOGLE or GOOGLE Earth, which hosts a multitude of other information not restricted to the geographic location information. The result of the feed directs a verification of the geo location of the accident, based upon accident information supplied by the user to illustrate the latitude and longitude of the location as well as street level mapping. User Input 102 may trigger Vehicle Damage Information 106 to be obtained, for example, from an external data network which provides repair estimate data. Also pinpointed bodily injury information from User Input 102 may direct communication with an external data source provider, for example, for estimates on injury values Bodily Injury Information 108. In cases prompted by membership and agreements with the sponsors/owners of an Advanced Automatic Collision Notification System 112, notification containing accident details may pre-populate an initial segment of the CONSUMER CLAIM SOLUTION SOFTWARE 110 when facilitated through 101 the Data Network Interface. The CONSUMER CLAIM SOLUTION SOFTWARE 110 may regulate data received by the Data Network Interface 101 to calculate, and provide solutions.

In some embodiments, the CONSUMER CLAIM SOLUTION SOFTWARE [CCSS] program provides individual financial formula-based outcomes, along with specific techniques for successful case closure for consumers as part of a computer network, enabling multiple and simultaneous points of access, thus allowing a single user, dozens of users or thousands of users to access and interface with the program simultaneously using one or more computers, or other electronic device capable of accessing the Internet and interacting with the software.

Referring to FIG. 1, the system accesses a privately-owned server (such as The Weather Channel, or other servers), a server computer not shown, which hosts a multitude of other information not restricted to historical weather information, and will be activated based upon the time, date and location of the accident. The result of the feed directs a verification of past weather events, based upon the accident location, time and date of loss supplied by the user.

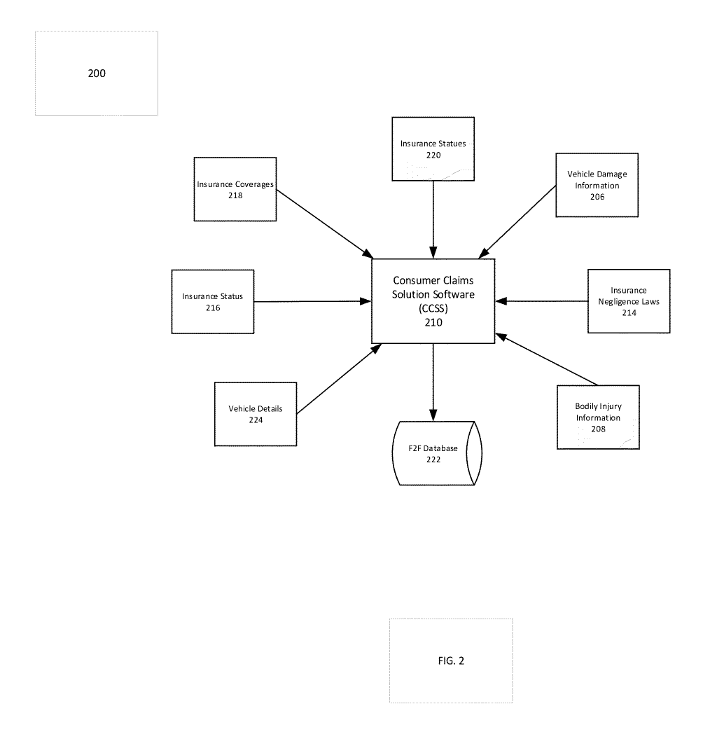

FIG. 2 is a block diagram 200 of an embodiment of a series of subroutines whereby the CONSUMER CLAIM SOLUTION SOFTWARE program access several existing external databases for the purpose of building components of the total claim for proper evaluation, calculation and solution.

For example, Vehicle Damage Information 206 details the physical nature of the damage or loss. Bodily Injury Information 208 provides details on the source and extensive nature of injury to be routed into the CONSUMER CLAIM SOLUTION SOFTWARE 210, combined with details of the users' existing Insurance Coverage 218, and if the existing Insurance Coverage 218 is confirmed by Insurance Status In Force 216 being affirmative. The time horizon for pursuit of the claim for negotiation purposes and statutes of limitation changes is activated and confirmed via each individual state, and the District of Columbia Insurance Statutes database 220, based upon the date of the accident. Updated information on liability laws, and changes in said laws, is gathered through the Insured Negligence Laws database 214.

In addition, external Vehicle Details may be accessed through a company such as Nexus Lexus source 224. This resource allows the system to properly identify all aspects of the vehicle to provide optional negotiation beyond the stated amount of the repair estimate provided by a given body shop. Also illustrated is a Database 222 for storing data gathered by the CONSUMER CLAIM SOLUTION SOFTWARE 210.

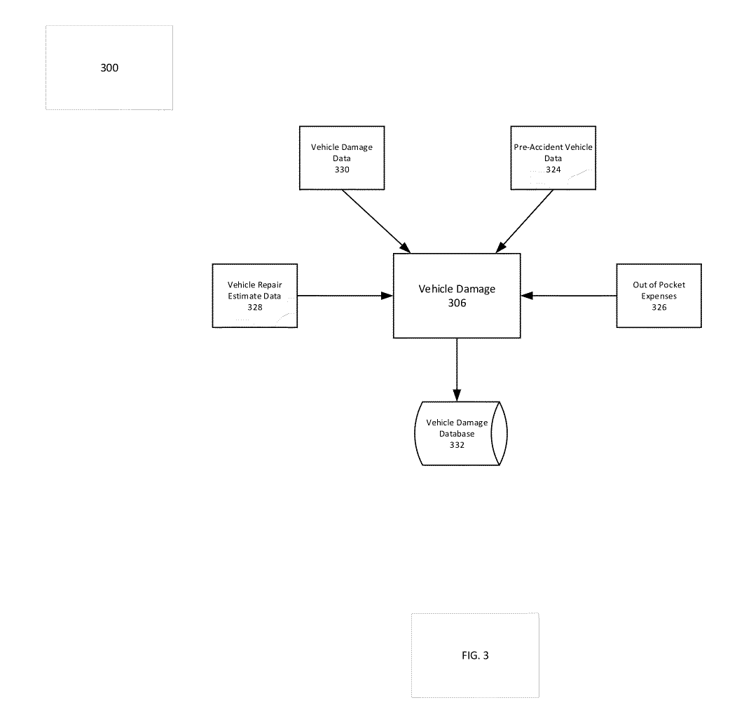

FIG. 3 is a block diagram 300 depicting the data flows involved in the calculation of an automobile value after an accident, whereby the post-accident value is evaluated in contrast with the pre-accident value to gain a “Depreciation” value or depreciated value difference, which can be negotiated as a segment of the total claim value based upon infusion of details: Out-of-Pocket Expense Data source 326, Repair Estimate Data source 328, Vehicle Damage Data source 330 into the Vehicle Damage Information (block 306) data flows involved in the calculation of an automobile value after an accident, whereby the post-accident value is evaluated in contrast with the pre-accident value to gain a “Depreciation” or a depreciated value difference, which can be negotiated as a segment of the total claim value.

In the embodiment depicted by FIG. 3 (block 324) Pre-Accident State, the “Depreciation” will rely upon (1) Age of the vehicle; (2) Make of the vehicle; (3) Model of the vehicle; (4) Type (for example: Luxury, Midsize, Compact, Hatch); (5) Mileage of the vehicle, and may rely upon other factors associated with the vehicle details. Vehicle values by year can also be accessed through companies like Edmunds, for example, to provide optional negotiation beyond the stated amount of the repair estimate provided by a given body shop. The combination of these variables, calculated within the software program, may provide the basis of the additional amount for “Depreciation” negotiation which flows directly into the Vehicle Damage Database 332.

In some embodiments, in addition, FIG. 3 is also block diagram 300 depicting the data flows involved in the calculation of an automobile value after an accident, whereby the post-accident value is evaluated in contrast with the pre-accident value to gain a “Before & After” difference value, which can be negotiated as a segment of the total claim value

Also, in the embodiment depicted by FIG. 3 (block 324) Pre-Accident State, the “Before & After” will rely upon (1) Age of the vehicle; (2) Make of the vehicle; (3) Model of the vehicle; (4) Type (for example: Luxury, Midsize, Compact, Hatch); (5) Mileage of the vehicle, and may rely upon other factors associated with the vehicle details. The combination of these variables, calculated within the software program, may provide the basis of the additional amount for “Before & After” negotiation which flows directly into the Vehicle Damage Database 332.

Referring to FIG.3, the Pre-Accident State accesses a privately-owned server (such as Nexus Lexus), a server computer not shown, which hosts a multitude of other information not restricted to the Vehicle Identification Number/VIN information. The result of the feed directs a verification of vehicle features and standard equipment for each Vehicle Identification Number/VIN supplied by the user.

Referring to FIG. 3, the Pre-Accident State accesses a privately-owned server (such as Edmunds), a server computer not shown, which hosts a multitude of other information not restricted to the vehicle value information. The result of the feed directs a verification of vehicle wholesale, retail and/or trade-in values for each Vehicle Identification Number/VIN supplied by the user.

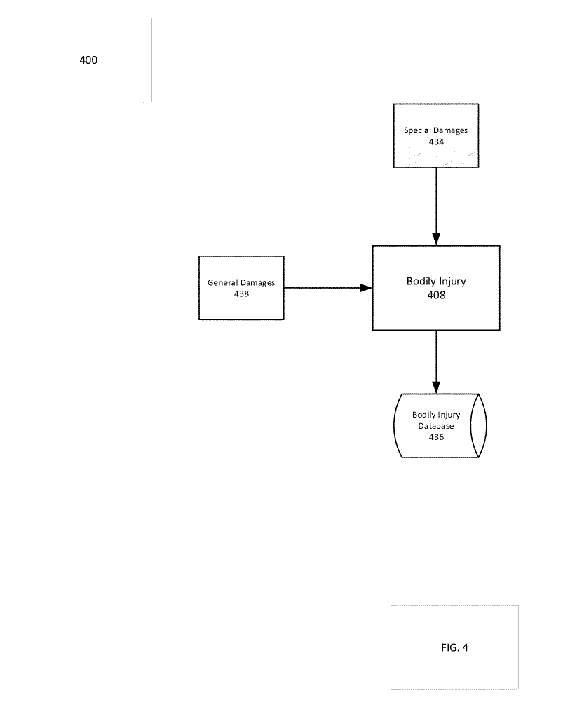

FIG. 4 is a block diagram 400 depicting the data flows involved in the calculation of an injury-based pain & suffering value after an accident, whereby the post-accident injury and quality of life value is evaluated in contrast with the pre-accident value to gain a difference, which can be negotiated as a segment of the total claim value.

In an embodiment depicted by FIG. 4, the calculations will rely upon body location of impact and injury/injuries selected by user for Bodily Injury Information 408, including Special Damages 434 and General Damages 438, the expenses incurred, an internal calculation, and any combination of the following variables and/or associated variables, descriptions and/or more detailed descriptions of 408 which may apply: Head, Scalp, Ear, Face, Eye, Nose, Mouth, Neck, Jaw, Chest, Sternum, Lateral Chest, Abdomen, Upper Abdomen, Lower Abdomen, Pelvis, Groin, Hip, Genitals, Leg, Thigh, Knee, Shin, Ankle, Foot, Toes, Back, Upper Spine, Lower Spine, Buttock, Hip, Hamstring, Back of Knee, Calf, Sole, Arm, Upper Arm (triceps), Shoulder, Elbow, Forearm, Wrist, Hand, Fingers, Upper Arm (bicep), Forearm (flexor), Palm, Job Loss, Scarring Face/Neck/Head, Scarring Torso, Scarring Arm/Hand, Scarring Back, Scarring Leg/Foot, Loss of Limb, Loss of Use of left arm, Loss of Use of right arm, Loss of Use of right hand, Loss of use of left hand, Loss of use of left leg, Loss of use of right leg, Loss of use right foot, Loss of use left foot, Paraplegic, Quadriplegic, Loss of Senses. Any single entry or combination of these variables, calculated within the software program and triggered for entry into the Bodily Injury Database 436, provide the basis of the additional amount for negotiation on behalf of the user and for legal counsel, if that option is selected by the user.

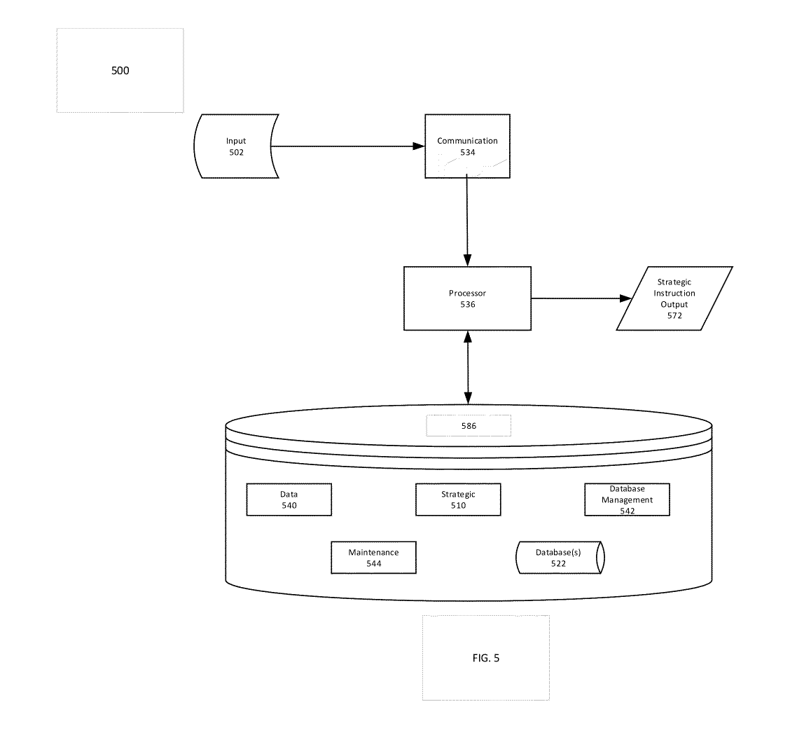

FIG. 5 is block diagram 500 illustration of an embodiment of a claim solution system which may symbolize aspects of a Data Network Interface 101 and a CONSUMER CLAIM SOLUTION SYSTEM 110 presented in FIG. 1. As shown in the diagram, the CONSUMER CLAIM SOLUTION SYSTEM includes Input 502 from the user, including other input triggered as an event in response to user input, bi-lateral Communication 534 via a device which includes a desktop computer, computer operated desktop devices, computer operated laptop devices, notebook, tablet, hand-held device, mobile device or smart phone: with or without audio output and/or print capability; with reception and viewing capability; a mouse, keyboard, keypad, touch screen, hover screen, voice recognition or other manually manipulate-able interface for controlling on-screen cursor movement or activity; a readable medium; a saving function to act as a repository for output document reference; word processing software; Internet Access; (a diagram not shown) receptacle for an Advanced Automatic Collision Notification System (activated via separately developed application specifically designed for download using server-side and/or client-side processing) containing accident data (e.g. GPS position, date, time, damage source, injuries, alerted emergency assistance, etc.); and a system to communicate with various mobile, notebook or desktop application software to both generate specific questions, and provide tailored solutions; and a system to communicate with and receive data from Advanced Automatic Collision Notification System containing accident data (e.g. GPS position, date, time, damage source, injuries, emergency assistance, etc.).

In some embodiments, the Communication acts as an information exchange device 534 transmitting data wirelessly to, the user devices, and receives wirelessly sent data from user devices. Once again as referenced in FIG. 5, the user input device 502 encompasses, for illustrative purposes, a desktop computer, notebook, tablet, hand-held device, mobile device or smart phone: with or without audio output and/or print capability; with reception and viewing capability; a mouse, keyboard, keypad, touch screen, hover screen, voice recognition or other manually manipulate-able interface for controlling on-screen cursor movement or activity; a readable medium.

In some embodiments, the Communication 534 system encompasses functionality capable of effectively communicating with users, enabling multiple and simultaneous points of access, thus allowing a single user, dozens or thousands of users to access and interface with the program simultaneously using one or more computers, or other electronic device(s) capable of accessing the Internet and interacting with the software.

User output device(s) not illustrated in the diagram, may encompass, for instance a display screen, printer or speaker, a saving function to act as a repository for output document reference; word processing software; and Internet Access.

Storage device 586 may incorporate any pertinent information storage device, containing amalgamations of magnetic storage devices (e.g., magnetic storage disk, Zip disk, cartridge, portable drive, magnetic tape and hard disk drives, removable disks), optical storage devices (e.g. compact disc, digital versatile/video disc, high definition DVD, Blu-ray), and/or semiconductor memory devices such as read/write RAMs (DRAMs for dynamic and SRAMs for static storage, and/or pseudo dynamic RAMs), mask-programmable read-only (ROMs), fuse-programmable read-only (PROMs), ultraviolet-erasable programmable read-only (UV EPROMs), electrically alterable read-only (EAROMs), electrically erasable programmable read-only (EEPROMs), flash EPROMs, nonvolatile static RAMs (NV RAMs) and ferroelectric memories.

Several of the aforementioned devices may be regard as a computer readable medium and/or a computer-readable storage means, or may comprise such means, or dedicated hosting.

In some embodiments, the computer equipment and peripheral features supporting the CONSUMER CLAIM SOLUTION SOFTWARE [CCSS] program may be common.

Storage Device 586 warehouses one or several programs, program segments and/or applications, or sections of programs, program segments or applications (a few being indicated by blocks 510, 522, 540, 542 and 544) to regulate Processor 536. A key provision is the programs, program segments and/or applications which include commands designed to direct the Processor 536 to execute functions, and consequently run in accordance with aspects of the methodology divulged herein.

In some embodiments, the programs may include a program, program segments or Strategic application 510 which directs the computer 500 to receive, request initial or request additional and/or gather various types of data (see data 102, 104, 106,108, and 112 of FIG. 1, and 206-224 of FIG. 2, 306 of FIG. 3 and 408 of FIG. 4) from diverse sources required to calculate, and provide solutions according to the aspects described herein.

An additional feature is the program, program segment and or application contained within the Database Management inside block diagram 586, shown by block 542, which warehouses one or several programs, program applications and/or program segments designed to operate in conjunction with the Strategic Database 510, other Database(s) represented by 522, pertinent Data shown in block 540 and the Processor 536 to execute tasks, and coordinate the calculation, retrieval, matching and solution functionality for Output as indicated on box 572, based upon the methodology shown in this document.

In continued reference to FIG. 5, Maintenance device 544 also warehouses several applications or programs and/or program segments designed to interface with each component of the CONSUMER CLAIM SOLUTION SOFTWARE for the purpose of adjustment and enhancement, which includes aspects denoted in FIG. 1 and FIG. 2, based upon the methodology shown in this document.

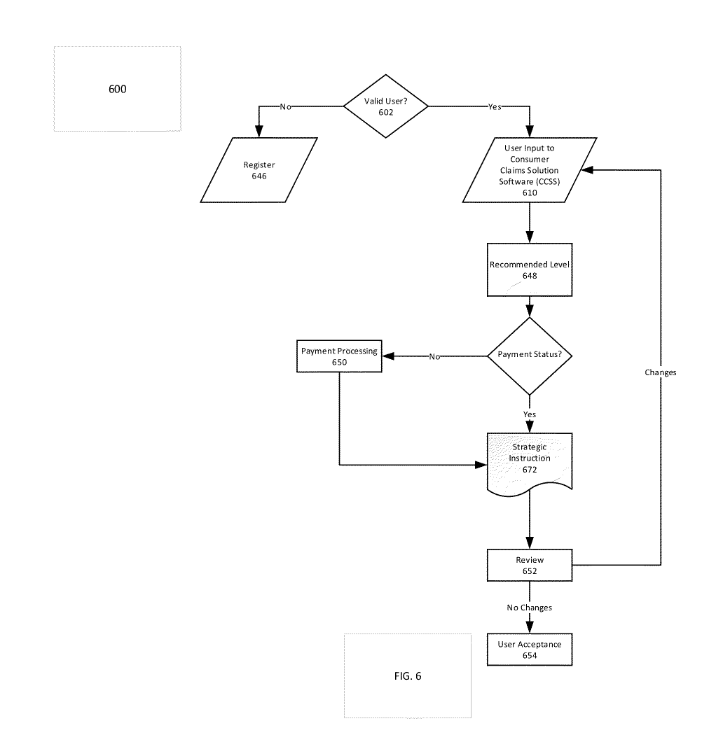

FIG. 6 is a block diagram 600 depicting the data flows involved in the User Input 102 and Data Network Interface 101 referenced in FIG. 1.

It should be inferred that in some embodiments users must first be registered as a valid user for the purposes of obtaining claim solution output, as referenced in block 646.

In some embodiments, access to the CONSUMER CLAIM SOLUTION SOFTWARE [CCSS] program functionality is restricted based upon the lack of an authorized user identification number and/or associated password. Not show are the typical display screens requiring the correct user information (when an unauthorized person or entity tries to access the program) for an account that has been previously established by a user, or has been populated from an Advanced Automatic Collision Notification System, storing at least an initial user-identifying credentials identifier and initial password based upon membership and pre-existing corporate affinity code of the entity owner of the Advanced Automatic Collision Notification System.

In continuation, should the person or entity enter an invalid identification number and/or associated password, a message may be displayed which says: “Invalid User ID and/or Password; Please try again”.

In some embodiments, a prompt to re-enter the user identification number and associated password may appear for a total of 5 attempts. If all attempts are exhausted, the program may show an additional message, for example, to “Reset Your Password” may appear, and “Enter Email Address” may be the language used to allow the user (if valid) to receive the original identification number and associated password via email. Invalid users or entities may receive messaging such as “Invalid User”, if unusable information is entered or an unrecognizable/unmatchable email address is submitted, and may not gain access to the program.

In some embodiments, when a valid user as indicated in block 602 accesses the system via registration as referenced in 646, the user will provide answers to questions illustrated in the Answer Questions block 610, based upon the prompts encountered in the Communication 534 interaction of FIG. 5.

In some embodiments, the system will provide a Recommended Level of solution as indicated in block 648, the user may continue the process by engaging Payment in box 650. This action prompts the Strategic Instruction to be generated in box 672, along with a user review of the input variables under Review 652, with an option to make any needed material changes, which is a redress of the questions whereby the users correctly answers questions noted by box 610. This cycle may continue until the user indicates no changes are necessary, thus in effect by-passing box 650 (because payment has already been rendered) and accepts the output generated as indicated in block 654 User Accept, in accordance with aspects of the methodology divulged herein.

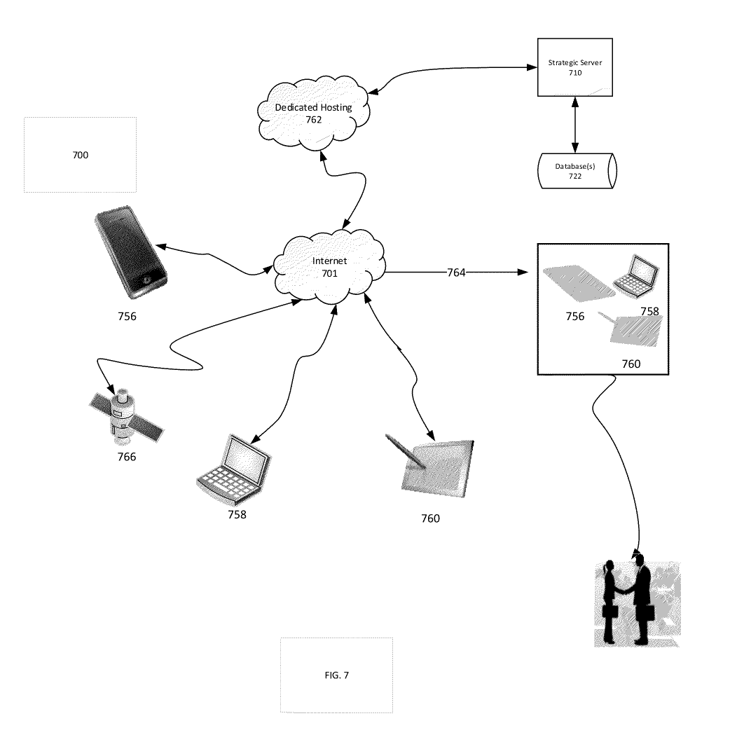

FIG. 7 is a block diagram representation of a system 700 in accordance with further aspects described herein. Expressly, a user holding or using a handheld device [for example a cellular telephone] 756, a laptop computer 758 or a notebook/tablet 760 or Advanced Automatic Collision Notification System 766 as illustrated accessing the CONSUMER CLAIM SOLUTION SOFTWARE program Strategic Server Computer 710 via a via the Internet 701 and Dedicated Hosting 762. The Internet hosting 762 may be a private hosting network designed to allow access to the CONSUMER CLAIM SOLUTION SOFTWARE program via the parent company website.

The CONSUMER CLAIM SOLUTION SOFTWARE program's Strategic Server 710 may be designed to connect and communicate to one or several Databases 722 for wired and wireless communication to an array of user devices.

In some embodiments, expressly, a user may utilize several types of devices to access the Strategic Server 710 to receive the resulting Solution 764 via a multitude of devices (some, but not all, of which are illustrated as examples) used to access the Internet 701, in accordance with aspects of the methodology divulged herein.

In some embodiments, input data is saved into a database 722 along with identification data and timestamps to provide an activity trail. In addition, in some implementations, management reports may be generated which provide trends of various types for system enhancements and marketing. For example, company reports which provide geographically concentrated accidents trends over selected periods, without weather-related influence, could shape geographical marketing efforts.

The process explanations and flow charts enclosed herein should not be considered to denote a fixed method for performing the referenced process steps. Hence, process steps may instead be performed in any order that is feasible, including the orders reference in the chart below.

The present invention has been described in terms of numerous embodiments solely for illustration. A Person skilled in the art will recognize from these descriptions that the invention is not restricted to the embodiments described, but could be accomplished with modifications and revisions limited only by the essence and scope of the appended claims.

Described are computer methodology, apparatus, systems and computer-readable data storage channel storing commands for executing vehicle loss, physical loss and pain & suffering calculations for the purpose of consumer negotiation with a property & casualty insurer. In an embodiment, a computer system or methodology for performing vehicle loss calculations, physical loss and pain & suffering calculations include an electronic device coupled to the computer and the CONSUMER CLAIM SOLUTION SOFTWARE [CCSS]. The storage device includes a multifaceted application program having operating instructions to command the software program to receive a variety of accident and injury variables, which include geographical locations and jurisdictions, and forward to a calculator application. The instructions also command the software to allow the user to input an array of automobile accident variables, which are state, vehicle and circumstantially-specific, with verification to assure accurate responses to questions regarding the incident. The culmination of user input and software calculations is a readable set of values and instructions designed to negotiate a higher value automobile insurance accident claim settlement within a shorter time frame.

1. A software system providing to a user a pre-formatted logical arrangement of computer-implemented guidelines which, when executed via a user's desktop or mobile automated device, generates a user interface viewable on a presentation device joined to the user's device, thus displaying to the user, in a first segment of the user interface, a multitude of solicitations for a set of personal information describing characteristics of the user, automobile accident variables, related injury and financial information received since the accident occurred; receiving via the user interface, or automated facilitator, the personal and accident-related set of information; based on the set of personal information describing characteristics of the user, automobile accident variables, related injury and financial information received since the accident occurred, displaying the multitude of questions and results category simultaneously, generating to a second segment of the user interface a worksheet of injury information to be entered by the user, based upon the severity of the information entered into the first segment of the user interface; generating to a third segment of the user interface a worksheet a second worksheet of injury information to be entered by the user, based upon the type of injury information entered into the second segment of the user interface. The viewable user interface displays the multitude of questions and resulting instructions designed for negotiation.

2. The software system of claim 1, further containing operational instructions which renders decisions based upon user responses to the accident-related state or jurisdiction, geo-coded location, number of vehicles, time of day, weather conditions, at-fault [if determined], active insurance, age and conditions of vehicle, type of vehicle, policy coverage, injury and medical expenses, all designed to determine applicable insurance laws, liability share, likely traffic patterns, probable visibility, values, coverage availability and value relativity.

3. The software system of claim 1 further containing operational instructions to detailed components of the system which includes a desktop computer, notebook, tablet, hand-held device, mobile device or smart phone: with or without audio output and/or print capability; with reception and viewing capability; a mouse, keyboard, keypad, touch screen, hover screen, voice recognition or other manually manipulate-able interface for controlling on-screen cursor movement or activity; a readable medium; a saving function to act as a repository for output document reference; word processing software; Internet Access; a receptacle for an Advanced Automatic Collision Notification System (activated via separately developed application specifically designed for download using server-side and/or client-side processing) containing accident data (e.g. GPS position, date, time, damage source, injuries, alerted emergency assistance, etc.); a system to communicate with various mobile, notebook or desktop application software to both generate specific questions, and provide tailored solutions; and a system to communicate with and receive data from Advanced Automatic Collision Notification System containing accident data (e.g. GPS position, date, time, damage source, injuries, emergency assistance, etc.).

4. The method of claim 1, further containing, prior to the operational instructions for directing the CONSUMER CLAIM SOLUTION SOFTWARE [CCSS] software to receive acceptable user information, operational directives to direct the CONSUMER CLAIM SOLUTION SOFTWARE [CCSS] software to receive a newly authorized or returning user-identifying characters and password; determine that the user identifying characters and password correspond to a user with authorization to access the CONSUMER CLAIM SOLUTION SOFTWARE [CCSS]; and provide the access and/or re-access to the data screens designed to calculate and generate provision of values and negotiation steps, wherein at least one of posing requests and generating the worksheet, and receiving the information set is performed by a second electronic device remote from the user's automated device.

5. A method of claim 1 further containing operational instructions encompassing and providing to a user a pre-formatted logical arrangement of computer-implemented guidelines which, when executed via a user's desktop or mobile automated device, generate a user interface viewable on a presentation device joined to the user's device, thus displaying to the user, in a first segment of the user interface, a multitude of solicitations for a set of personal information describing characteristics of the user, automobile accident variables, related injury and financial information received since the accident occurred; receiving via the user interface the personal and accident-related set of information; based on the set of personal information describing characteristics of the user, automobile accident variables, related injury and financial information received since the accident occurred, displaying the multitude of questions and results category simultaneously, generating to a second segment of the user interface a worksheet of injury information to be entered by the user, based upon the severity of the information entered into the first segment of the user interface; generating to a third segment of the user interface a worksheet a second worksheet of injury information to be entered by the user, based upon the type of injury information entered into the second segment of the user interface. The viewable user interface displays the multitude of questions and results.

6. The method of claim 4, supplementary involving storing the received personal information describing characteristics of the user, automobile accident variables, related injury and financial information received since the accident occurred for use in an automobile CONSUMER CLAIM SOLUTION SOFTWARE [CCSS] software program.

7. The method of claim 4, further involving operational instructions for conveying the stored answers to the automobile CONSUMER CLAIM SOLUTION SOFTWARE [CCSS] software program, with an internally generated associated claim number.

8. The method of claim 1, further involving operational instructions to direct and activate a reference trigger for each automobile accident numerical value variable, connected via software program to multiple pre-determined financial factors and most suitable variable-sensitive solution factors to address the circumstances. When numerical values are entered by the user, each of the multiple pre-determined financial factors and most suitable variable-sensitive solution factors are individually activated and placed into cue for proper alignment placement within the value ranges and prescription document.

9. A method for providing a reference trigger within each pre-determined choice of each automobile accident variable, connected via software program to multiple pre-determined most suitable variable-sensitive solution factors to address the circumstances. When choices are selected by user from the menu or list, pre-determined most suitable variable-sensitive solution factors are activated and placed into cue for proper alignment placement within the prescription document which details values and negotiation steps.

10. The method for providing variables and step-by-step negotiation steps, based upon all of the active most suitable variable-sensitive solution factors to address the circumstances once they are activated and placed into cue for proper alignment, the entire general list of strategic negotiation steps are initiated from different tables to complete the variables and negotiation steps letter/worksheet for usage. User will be able to view limited details of the letter/worksheet, without print or print screen capability, and accepts conditions prior to rendering payment.

11. The method for directing the user to a payment portal within the software program established by the site for the purpose of completing the transaction and accessing a full-readable document ready for download and print, while initiating a simultaneously supplementary process involving the storing the information for future access based upon a pre-assigned claim number.

12. The method of claim 4, further involving operational instructions comprising the method whereby the user's electronic device, various mobile, notebook or desktop application software or Advanced Automatic Collision Notification System accesses a remote electronic system designed to communicate with the CONSUMER CLAIM SOLUTION SOFTWARE [CCSS] software program, storing at least an initial user-identifying credentials identifier and initial password.

13. The method of claim 12, further encompassing the method whereby the software facilitates an electronic system capable of receiving information from an Advanced Automatic Collision Notification System, various mobile, notebook or desktop application software.

14. The method of claim 5, further encompassing the method whereby the software facilitates and directs all electronic information received from Advanced Automatic Collision Notification System or user electronic device such as mobile, notebook or desktop application through a software channel where it is stored and matched with pre-formatted corresponding reactions for each variable.

15. The method of claim 1, further encompassing the method whereby the software facilitates an electronic system to insert the set of personal information describing characteristics of the user into a part of the database designed to personalize the system responses.

16. The method of claim 8, further encompassing the method whereby the software facilitates and triggers an electronic system subroutine involving mathematical calculations performed specifically based upon the financial information entered by the user, designed to provide financial variables to the user for negotiation.

17. A computer readable medium warehousing constant directives for regulating the CONSUMER CLAIM SOLUTION SOFTWARE [CCSS] software program, the directives are designed to trigger the software to receive a system-generated claim number, provide to the user a range of information and data input fields, drop-down fields and point-and-click options; verify that all necessary information is submitted; facilitates and triggers an electronic system which builds components of the corresponding letter/worksheet based upon the compilation of matched pre-formatted corresponding reactions from user input variables.

18. The method whereby the software provides to the user a range of information which describes injury and associated recovery-related treatment terms and a body map image, with a choice of male or female, with both front and back views which can be zoomed in or out, encompassing such bodily injury input options, the user may select based upon the specific body part(s) affected by injury as a result of the automobile accident. The user may select a single body part, or multiple body parts by clicking the appropriate part of the human body map. All body map-based entries and associated injuries are totaled and displayed for user verification and correction, before the input is submitted. The submission facilitates and triggers an electronic system which provides the user a pre-formatted logical categorical pre-determined most suitable variable-sensitive solution and solution level, encompassing primary and ancillary information available at the appropriate level, along with an option to accept or select a different solution level.

19. The method whereby the software provides to the user an automobile body map image, with front, back, side(s), top, interior and under carriage views which can be zoomed in or out. The user may select based upon the specific automobile body part(s) affected as a result of the automobile accident. The user may select a single vehicle body part, or multiple vehicle body parts by clicking the appropriate part of the automobile body map. All body map-based entries are totaled and displayed for user verification and correction, before the input is submitted. The submission facilitates and triggers an electronic system which provides the user a pre-formatted logical categorical pre-determined most suitable variable-sensitive solution and solution level, encompassing primary and ancillary information available at the appropriate level, along with an option to accept or select a different solution level.

20. The method of claim 8, further encompassing the manner whereby the software facilitates and triggers an electronic system which provides the user a pre-formatted logical categorical pre-determined most suitable variable-sensitive solution and solution level, encompassing primary and ancillary information available at the appropriate level, along with an option to accept or select a different solution level, with more or less comprehensive information in response to user input variables, and a warning notification illustrating a departure from the original solution, and the resulting associated changes. This denotes when the user alternative does not adequately address all of the necessary variables in order to provide the most suitable variable-sensitive solution for optimal negotiation, based upon the program.

21. The method of claim 8, further encompassing the method whereby the software facilitates and triggers a user accepted pre-formatted logical categorical solution level, encompassing primary and ancillary information available at the pre-determined most suitable variable-sensitive solution level based upon the accident information entered, and accepts the conditions of the site in order for the system to automatically allow partial view and opportunity to render payment.

22. The method whereby the software facilitates and triggers the electronic system which directs user to merchant account to render payment for selection made regarding pre-formatted and pre-determined most suitable variable-sensitive solution and solution level, encompassing primary and ancillary information available at the appropriate level, with the ability to see all of the features & benefits of each level, and the most appropriate level is highlighted and pre-selected, whereby user pays corresponding fee for level selected.

23. The method of claim 22, further encompassing the method whereby the software facilitates and triggers the electronic system which produces, and sends to print portal, a viewable, downloadable and printable set of solution documents designed to successfully address the related injury and financial information input by the user since the accident occurred.

24. The method whereby the software can be designed to make it possible to arrive at the same or similar pre-formatted logical categorical pre-determined most suitable variable-sensitive solution and solution level, encompassing primary and ancillary information available at the appropriate level by utilizing presently described claim systems and methods in an array of combination sequences. Some, which when grouped together, can be performed simultaneously.

25. The software readable medium of claim 4, further comprising, prior to the instructions for commanding the CONSUMER CLAIM SOLUTION SOFTWARE [CACSS] software program to receive the valid user identification number, instructions active to direct the CACSS software to: collect the user identification number and password simultaneously; verify that the user identification number and password combination match with the original user, with permission to access the application; and provide appropriate application access for variable entry, update or correction.

26. The software readable medium triggering post evaluation and value and negotiation steps output based upon injury components, the method whereby the software facilitates and triggers an electronic system which provides the user a pre-formatted logical choice of selecting legal counsel from an in-network list of Attorneys, an option to input the name, address and telephone number of their own out-of-network choice of legal counsel, an associated means of electronically signing a Health Insurance Portability and Accountability Act/HIPAA Form or to decline either choice. Each user decision triggers an electronic system to send automobile accident variables to the desired recipient. The system further differentiates the pre-determined amount of details and the pre-determined sending method based upon user choice, if one of the Attorney options is selected. In-network legal counsel will receive a PDF document via email with notification. The PDF will include all gathered accident details, along with negotiation steps provided to the user at no cost to the user. Out-of-network counsel will receive the gathered accident details, along with a cover letter via USPO or other service for a pre-determined fee.
